(19) United States
(12) Patent Application Publication
(10) Pub. No.: US 2007/0020974 A1
(43) Pub. Date: Jan. 25, 2007

(54) Tamper resistant plug to prevent removal of wire from a conduit

(76) Inventor: Donald A. Carlson, Kerman, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/516,998

(22) Filed: Sep. 7, 2006

Related U.S. Application Data
(63) Continuation-in-part of application No. 11/060,054, filed on Feb. 16, 2005.

(51) Int. Cl. H01R 13/648; H01R 4/66

(52) U.S. Cl. 439/105

(57) ABSTRACT

A tamper resistant plug configured to prevent unauthorized persons from pulling wires out of a conduit. The tamper resistant plug comprises a deformable, resilient engaging member that is operatively compressed by a compressing mechanism to radially extend its outer surface toward the conduit's inner surface. Each wire is received in a wire receiving groove on the outer surface of the engaging member such that compression of the engaging member tightly compresses the wires against the conduit to increase drag and prevent pulling the wires out of the conduit. The compression mechanism includes rigid members at each end of the engaging member and a biasing mechanism, preferably a bolt-like member that threadably connects to the distal rigid member or to a nut-like element, to bias the rigid members together. The head of the connector is configured to be tamper resistant and cooperatively engage the proximal rigid member to further prevent theft.

### CROSS-REFERENCE TO RELATED APPLICATIONS

None.

### BACKGROUND OF THE INVENTION

A. Field of the Invention

The field of the present invention relates generally to devices for preventing removal of cable or wire from a conduit. More particularly, the present invention relates to such devices that are configured as a removable plug which is received in a conduit so as to prevent theft or other unauthorized removal of wire from the conduit. Even more particularly the present invention relates to such plug devices that are configured to effectively engage one or more wires in a conduit to prevent unauthorized removal of the wire behind the plug while allowing the wires to pass through the plug.

B. Background

Various electrically conductive metals are utilized for wires in wiring systems to transmit electricity or electrical signals from one location to another. The most common and popular of the electrically conductive metals is copper. Unfortunately, as the value of the metal utilized to manufacture electrical wire increases, so does the theft of the wire. Although the thief can steal wire to use it in another wiring system, perhaps the most common destination for the stolen wire is to take it to a recycling or other processing facility to reduce the wire to its basic metal so that the metal can be more easily transported and sold to others. With the recent increases in the price of copper, this has become a particular problem with regard to copper wire. Unfortunately, due to the ease of access to electrical wires, the ease of processing the wire to a different form and the difficulty in tracking the metal back to its wire origin, this is a very difficult crime to prevent and solve.

One easily accessible source of wire for the wire thief to steal are the electrical pull boxes commonly utilized in most communities in the United States and throughout the world. Electrical pull boxes are manufactured in a generally box-like configuration having a removable lid and one or more conduit entry points to receive wire into the inner chamber defined by the walls and lid of the pull box. Although other materials are use, precast reinforced concrete is the most common material utilized for electrical pull boxes, such as those made by Christy, Utility Vault, Formi and others. The typical electrical pull box is configured to receive wire into the chamber through one or more sides of the pull box and to allow wire to exit the chamber through one or more of the sides. The incoming wires are connected to the outgoing wires in the chamber. In the typical configuration, the incoming and outgoing wires are disposed in appropriately configured and sized conduits to protect the wire from exposure to the elements and to reduce the likelihood of damage or other mishap causing a disruption in the electrical transmission. The electrical codes of most cities, counties and states, which are typically based on or incorporate the National Electrical Code, set forth the requirements for the use of electrical pull boxes, including the size and spacing requirements. For instance, some communities require that pull box spacing not exceed 200 feet.

For the thief interested in stealing wire, pull boxes are a relatively easy target as they are typically located in open areas that can be accessed somewhat privately at night. Because the wires are generally loose (i.e., not sealed) in their respective conduits, all the thief has to do is to take the pull box lid off, cut the wires at their connection and then pull on the wires to remove them from the conduit. Although pull boxes having locked or otherwise secured lids are generally available, these are not that much of a deterrent to the determined thief, as all he or she has to do in order to have free access to the wires in the chamber is to is to break the lock off of the lid or, perhaps even easier, break the concrete lid itself. Once access to the chamber is gained, the wires are relatively easily cut and then pulled out of their respective conduits and then taken for recycling/processing into the base metal. In addition to the cost of replacing the stolen wire itself, which for some entities can be hundreds of thousands of dollars per year, the affected entity must incur costs to re-run the wire through the conduit and, as necessary, connect the wires to the electrical system. Naturally, prior to the system being re-wired, the lights or other electrical devices on the system will not be able to operate, which can be a major inconvenience or even a danger to some.

Over the years, various devices have been developed to seal one or more wires in a conduit, generally for purposes of preventing moisture into the conduit or for preventing electrical shorts and/or induction heating. For instance, U.S. Pat. No. 6,431,215 to Hsu discloses a conduit plug having a securing element that threadably engages a retainer to deform an elastomer member tightly around the outer periphery of the cable and to cause the outer faces of the elastomer member to sealably engage the inner periphery of the conduit to provide double water leakage protection to the conduit. U.S. Pat. No. 4,622,436 to Kinnan discloses a plug assembly for encapsulating a cable within a conduit having a pair of ring members formed of a resilient material with an inner wall conformable to the cable's outer surface, a rigid spacer disposed between the ring members to define a sealant-receiving channel therebetween and a compression mechanism for deforming the ring members in the axial and radial direction. In the preferred embodiment, the compression mechanism comprises a pair of rigid members on the outward ends of the ring members and a bolt/nut connector that passes through the plug assembly to bias the ring members together. Sealant material, such as silicone, is dispensed into the channel to provide a seal between the ring members and the cables and to cushion the cable when it contracts, expands and shifts longitudinally to prevent water and gas intrusion. U.S. Pat. No. 4,762,151 to Kinnan discloses a blank plug assembly for sealing a conduit that comprises an annular, deformable sealing member disposed between a pair of substantially parallel opposed disks at the ends of the sealing member that are drawn together by a screw fastener extending through the plug assembly. The disks include a concentrically located collar and radial ribs joining the collar and an annular flange of the disk. Drawing the disks together causes the sealing member to expand radially and seal against the interior surface of the conduit. In addition to the patented devices set forth above, various other conduit sealing devices are available, such as cable terminators, compound bushings and conduit sealing bushings (i.e., those available from O-Z/Gedney and others), for use on conduit ends and cable ends to seal the cable and conduit against the entrance of water, damp or corrosive atmospheres, hot or cold air or dust.

None of the foregoing prior art devices provide a mechanism that is configured to releasably secure one or more wires in a conduit so as to prevent an unauthorized person from stealing the wire. What is needed, therefore, is a tamper resistant plug for a conduit that allows wires to extend past the plug yet prevent removal of the wire from behind the plug so as to prevent theft of the wire. The preferred tamper resistant plug should be configured to be easily and quickly installed at the end of a conduit to secure the wires behind the plug such that a person cutting the wires will be unable to pull the wire out of the conduit unless he or she has the proper tool to disengage the plug. Preferably, the tamper resistant plug is configured to engage the inner surface of a section of conduit in a manner that secures one or more wires between the plug and the conduit to increase the drag on the wire to prevent removal of the wire from the conduit. The preferred tamper resistant plug should be adaptable to a wide range of conduit and wire sizes.

### SUMMARY OF THE INVENTION

The tamper resistant plug of the present invention solves the problems and provides the benefits identified above. That is to say, the present invention discloses a tamper resistant plug for use in a section of conduit carrying one or more wires that is configured to allow the wire(s) to extend past the plug in a manner that prevents a person from removing the wire from the conduit. In a preferred embodiment of the present invention, the tamper resistant plug is easily and quickly installed at or near the end of a section of conduit in a manner that secures the wires against the inner surface of the conduit to increase the drag on the wires if they are pulled, thereby preventing removal of the wires from the conduit. The preferred embodiment of the tamper resistant plug of the present invention includes a mechanism to allow authorized persons to disengage the plug for removal from the conduit and/or pulling of the wires, while preventing unauthorized persons from doing the same. In the preferred embodiment, the present tamper resistant plug is adaptable to a wide range of conduit and wire sizes.

In one general aspect of the present invention, the tamper resistant plug for preventing removal of wires from a conduit comprises a deformable engaging member that is compressed by a compression mechanism to tightly engage the wires against the inner surface of the conduit. The engaging member has a proximal end, a distal end, an outer surface disposed between the two ends and a bore disposed through the engaging member. The engaging member is formed from a resilient material, such as rubber or thermoplastic and thermoset materials, that is suitable for compressing to radially expand its outer surface. The outer surface of the engaging member is generally in conforming relation with the inner surface of the conduit, which in a typical configuration will result in the engaging member having a circular cross-section. The outer surface of the engaging member is provided with one or more wire receiving grooves that each have an outwardly facing engaging surface that is generally dimensioned to receive one of the one or more wires. Although the wire receiving grooves can be generally arc-shaped grooves that the wires lay against, it is preferred that the grooves have an outer reach that generally folds in on itself to receive one of the wires therein in a substantially “snap-in” manner to retain the wire in the groove while the user places the plug into the conduit.

In the preferred embodiment, the compression mechanism comprises a first rigid member disposed at the proximal end of the engaging member, a second rigid member disposed at the distal end of the engaging member and a biasing mechanism configured to bias the two rigid members together so as to compress the engaging member therebetween. The first rigid member has a first aperture in substantial alignment with the bore and one or more first annular grooves on an annular edge thereof that are in substantial corresponding arrangement with the wire receiving grooves on the engaging member. The second rigid member has a second aperture that is also in substantial alignment with the bore and one or more second annular grooves on its annular edge that are also in substantial corresponding arrangement with the wire receiving grooves. The engaging member can have a recessed section at its proximal end that is defined by one or more upstanding sidewalls and shaped and configured to receive the first rigid member therein such that the edges of the first rigid member do not extend above the sidewalls.

In the preferred embodiment, the biasing mechanism comprises an elongated connector having a proximal end disposed at the first rigid member and a distal end generally disposed at the second rigid member. The connector has a head member at its proximal end that engages the first rigid member to compress the engaging member. Preferably, the head member is of the type that is configured to be substantially tamper resistant or tamper proof, as utilized for tamper resistant screws or bolts that require a specially configured or proprietary bit to engage. In the preferred embodiment, the first rigid member has a recessed area on its proximal side that is shaped and configured to receive the head member therein. Preferably, the recessed area and the head member are cooperatively configured to further deter unauthorized removal of the connector from the engaging member. A threaded section at the distal end of the connector threadably attaches to the second rigid member aperture or to a nut or other connector element behind the second rigid member such that when the connector is operated/tightened it biases the first and second rigid connectors toward each other. This compresses the engaging member therebetween to radially extend its outer surface so as to engage the inner surface of the conduit and secure the wires generally between the engaging member and the inner surface of the conduit. This substantially increases the drag when someone attempts to pull on the wires, thereby preventing removal of the one or more wires from the conduit unless the person first disengages the tamper resistant plug from its engagement with the conduit. A retaining mechanism, such as a retainer ring, can engage the distal end of the connector to prevent any components, particularly the second rigid member, from falling off the tamper resistant plug when it is disengaged from the conduit.

Accordingly, the primary objective of the present invention is to provide a tamper resistant plug to prevent removal of wire from a conduit that provides the advantages discussed above and overcomes the disadvantages and limitations associated with presently available conduit plugs and conduit sealing mechanisms.

It is also an important object of the present invention to provide a tamper resistant plug that is configured to be received in and selectively engage a conduit carrying one or more wires in a manner that allows the wires to extend past the plug while preventing unauthorized removal or theft of the wires from the conduit.

It is also an important object of the present invention to provide a tamper resistant plug for use in conduit having one or more wires that prevents removal of the wires from the conduit unless a specially configured tool is utilized to first disengage the plug from the conduit.

It is also an important object of the present invention to provide a tamper resistant plug having a deformable engaging member that is compressed by a compression mechanism so as to deform the engaging member in the axial and radial directions to secure one or more wires between grooves on the outer surface of the engaging member and the inner surface of the conduit.

It is also an important object of the present invention to provide a tamper resistant plug having a deformable engaging member disposed between a pair of rigid members that are biased toward each other so as to compress one or more wires between the engaging member and the inner surface of the conduit to prevent removal of the wires from the conduit.

It is also an object of the present invention to provide a tamper resistant plug that is adaptable to a wide range of conduit and wire sizes.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a tamper resistant plug configured according to a preferred embodiment of the present invention showing the tamper resistant plug disposed in a section of conduit with four wires extending past the plug;

FIG. 2 is a cross-sectional view of the tamper resistant plug, conduit and wires shown in FIG. 1;

FIG. 3 is a side perspective view of the tamper resistant plug of the present invention configured to secure up to four wires inside a conduit;

FIG. 4 is a cross-sectional view of the tamper resistant plug shown in FIG. 3;

FIG. 5 is an exploded side perspective view of the tamper resistant plug shown in FIG. 3 particularly showing the threaded connector and threaded aperture of the second rigid member as the biasing means;

FIG. 6 is a top plan view of the proximal side of the first rigid member used with the tamper resistant plug of a preferred embodiment;

FIG. 7 is a top plan view of the proximal side of the second rigid member used with the tamper resistant plug of a preferred embodiment;

FIG. 8 is an exploded side perspective view of a second configuration of the preferred embodiment of the tamper resistant plug of the present invention showing use of a threaded connector and nut as the biasing means and the use of curved wire receiving grooves; and

FIG. 9 is a side perspective view of a connector for use with the tamper resistant plug of the present invention particularly showing one configuration for the security feature.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily described as being utilized to prevent the theft of electrical wires from a conduit, those skilled in the art will readily understand that this is merely for purposes of simplifying the present disclosure and that the present invention is not so limited, as the present invention is equally applicable for use with a conduit to prevent theft of other types of wires.

A tamper resistant plug that is manufactured out of the components and configured pursuant to a preferred embodiment of the present invention is shown generally as 10 in the figures. Tamper resistant plug 10 is configured to be received in a conduit 12 to secure one or more wires 14 therein generally against the inner surface 16 of conduit 12, typically at or near the proximal end 18 thereof, as best shown in FIGS. 1 and 2. Tamper resistant plug 10 prevents thieves and other unauthorized persons from removing the wires 14 from conduit 12, as is presently accomplished by pulling the wires 14 out of conduit 12 during the theft of wires 14 for the purpose of reusing wires 14 or reducing them to the bare metal state. In a common configuration for the use of tamper resistant plug 10 of the present invention, wires 14 are coated copper wires used for the transmission of electricity or electrical signals. As set forth in more detail below, tamper resistant plug 10 of the present invention significantly increases the drag on wires 14 by engaging the inner surface 16 of conduit 12. If wires 14 are pulled without first disengaging tamper resistant plug 10, this drag will make it very difficult or nearly impossible to pull wires 14 out of conduit 12. As also set forth below, authorized personnel having the proper tool can disengage tamper resistant plug 10 so that they may service wires 14 as necessary or desired. Although its use is not so limited, tamper resistant plug 10 will be particularly useful for wires 14 that are exposed, for purposes of making connections, inside a pull box (not shown) or the like where the proximal end 18, that end being the end closest to where tamper resistant plug 10 is being utilized and wires 14 extend therefrom, of conduit 12 enters the pull box. As used herein, the term “proximal” generally refers to the end or side direction closest to where the human accesses tamper resistant plug 10 when used in conduit 12, that being the end from which wires 14 generally extend from conduit 12, and the term “distal” refers to the direction farthest away from where the human accesses tamper resistant plug 10 (i.e., opposite of the proximal end or side).

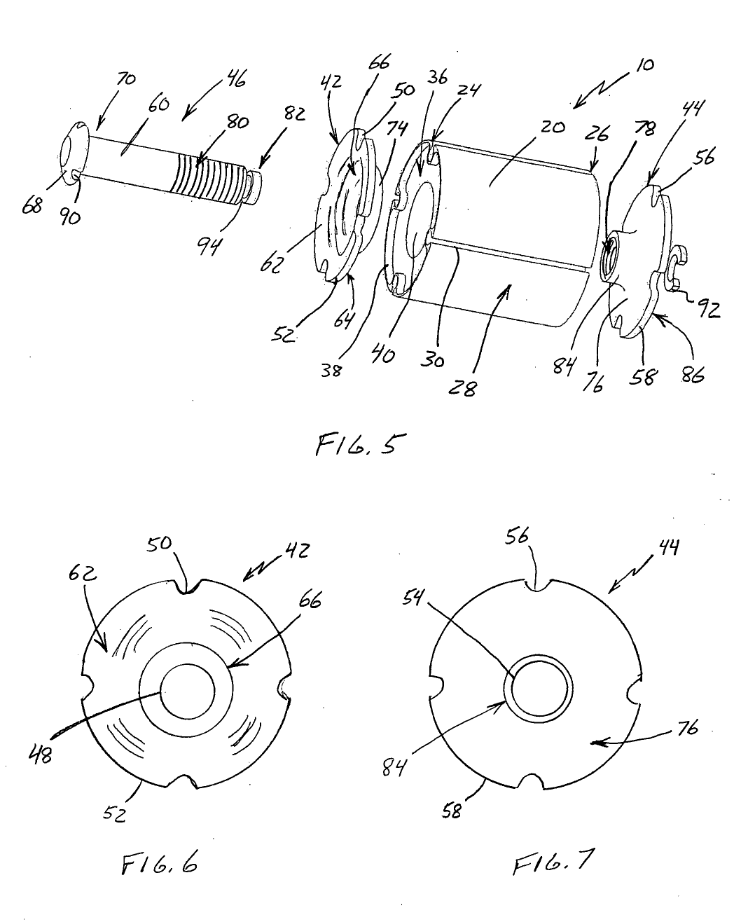

Tamper resistant plug 10 of the present invention primarily comprises a deformable engaging member 20 and a compressing means, shown generally as 22 in FIG. 5, associated therewith for compressing the engaging member to engage it against the inner surface 16 of conduit 12. In the preferred embodiment, engaging member 20 is formed from a resilient, elastomeric material, such as rubber or thermoset or thermoplastic materials that can be sufficiently compressed by compressing means 22 to cause engaging member 20 to expand and engage inner surface 16. Engaging member 20 has a proximal end 24, a distal end 26 and an outer surface 28 therebetween. The outer surface 28 of engaging member 20 is shaped and configured to generally conform to the configuration of inner surface 16 of conduit 12, which typically will result in engaging member 20 being generally cylindrically shaped to correspond to the typically cylindrical shaped conduit 12, as shown in the figures. When engaging member 20 is compressed by the compressing means 22, outer surface 28 will radially extend to engage inner surface 16, as shown in FIGS. 1 and 2.

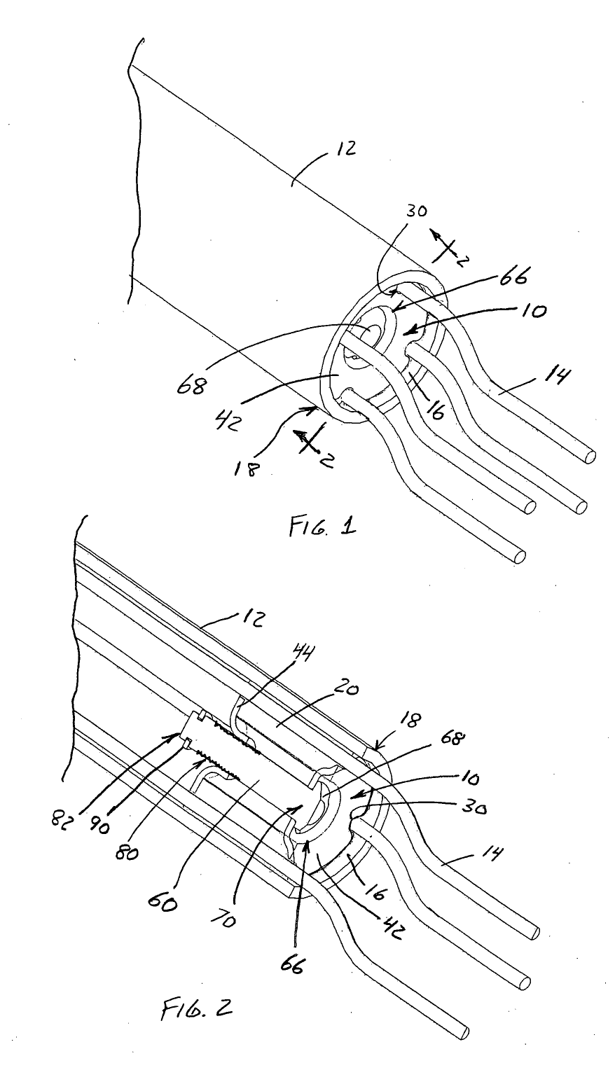

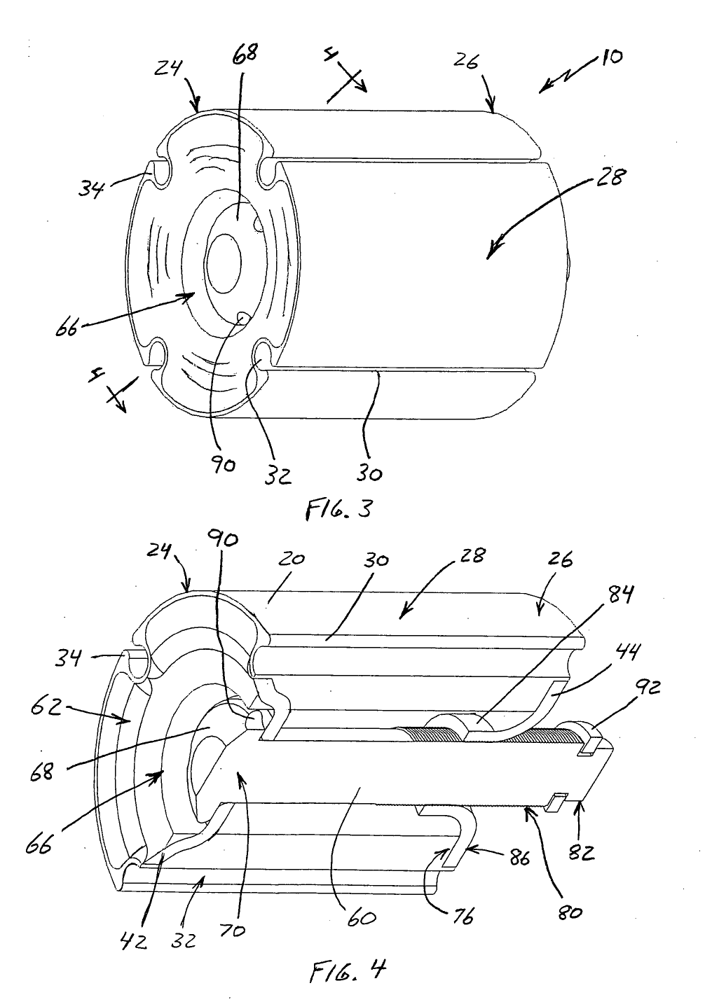

Outer surface 28 of engaging member 20 is provided with one or more wire receiving grooves 30 that are each shaped and configured to receive one of the wires 14 therein. As best shown in FIG. 4, each of the wire receiving grooves 30 have an outwardly facing engaging surface 32 dimensioned to receive one of wires 14 in wire receiving groove 30. Preferably, engaging surface 32 is configured in a general circular or semi-circular shape that corresponds to the standard round surface of wires 14 with the outer reaches 34, that being the edges at outer surface 28 (as best shown in FIGS. 3 and 4, of grooves 30 being shaped and configured to receive one of wires 14 in a “snap-in” or generally enclosing manner such that the wire 14 generally remains engaged in groove 30 by outer reaches 34 once the user places it therein. Although grooves 30 can be configured generally as an arc without outer reaches 34, as shown in FIG. 8, the use of the shaped outer reaches 34 simplifies the installation of tamper resistant plug 10 by maintaining the wire 14 inside groove 30 while the user is placing tamper resistant plug 10 inside conduit 12. This almost circular, snap-in configuration is also easier to use than a complete, closed circular shape (i.e., a hole without the side opening shown), which would require the user to thread wires 14 through tamper resistant plug 10. Wire receiving grooves 30 can be substantially straight along outer surface 28, as shown in FIGS. 3 through 5, or be in an s-shaped or other curve, as shown in FIG. 8. Depending on the materials used for engaging member 20 and the size of wires 14 relative to the size of the grooves, the curved wire receiving grooves 30 may have some advantages with regard to securing wires 14 therein.

For the preferred compressing means 22, set forth below, engaging member 20 is configured to cooperate therewith by having the proximal 24 and distal 26 ends provided with a recessed section 36 having an upwardly extending sidewall 38, best shown in FIG. 5 at proximal end 24 (though not shown, distal end 26 is similarly configured), that is generally set into or recessed below the proximal edge of engaging member 20 to receive components of compressing means 22 and by having a bore 40 (shown in FIG. 5) that is disposed completely though engaging member 20 from proximal end 24 to distal end 26. The use of recessed section 36 and bore 40 in engaging member 20, as well as the components associated therewith, are explained in more detail below.

Compressing means 22 is configured to compress engaging member 20 and radially extend outer surface 28 to engage inner surface 16 of conduit 12 with wires 14 disposed in wire receiving grooves 30 to prevent unauthorized removal of wires 14 from conduit 12. Preferably, compressing means 22 is also configured to allow an authorized person to disengage tamper resistant plug 10, by releasing the compression forces placed on engaging member 20, so that any necessary or desired work may be performed. In the preferred embodiment, compressing means 22 comprises a first rigid member 42 at proximal end 24 and a second rigid member 44 at distal end 26 of engaging member 20 and biasing means 46 for biasing first 42 and second 44 rigid members toward each other so as to compress engaging member 20 therebetween. First 42 and second 44 rigid members are formed of substantially rigid materials, such as metals or hard plastics. If metal is utilized, it is preferred that the material be chosen from those which are generally resistant to corrosion, such as stainless steel and the like. In addition, any material chosen for first 42 and second 44 rigid members should be selected from those which are known to be sufficiently tough, particularly with regard to the outwardly facing first rigid member 42, such that they are not easily damaged by a determined thief.

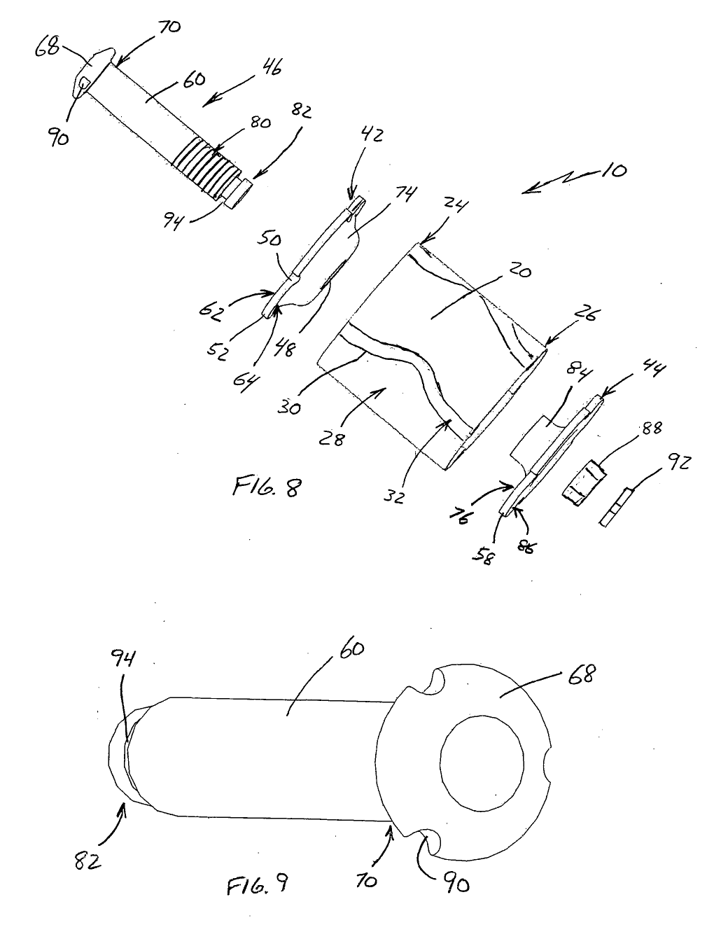

In one embodiment, first 42 and second 44 rigid members are a pair of substantially planar members that are disposed generally parallel to each other at opposing proximal end 24 and distal end 26 of engaging member 20. In a preferred embodiment, as shown in the figures, both first 42 and second 44 rigid members are shaped and configured to cooperate with engaging member 20 to provide a more secure and effective tamper resistant plug 10. In the preferred embodiment, first rigid member 42 has a first aperture 48 therethrough and one or more first annular grooves 50 in the annular edge 52 thereof and second rigid member 44 has a second aperture 54 therethrough and one or more second annular grooves 56 in the annular edge 58 thereof, as best shown in FIGS. 5 through 7. First 42 and second 44 rigid members are shaped and configured, cooperatively with engaging member 20, such that first aperture 48 of first rigid member 42 and second aperture 54 of second rigid member 44 are substantially aligned with bore 40 through engaging member 20 to receive the elongated connector 60 of the preferred biasing means 46. Likewise, first annular grooves 50 and second annular grooves 56 are in corresponding relation with the wire receiving grooves 30 on outer surface 28 of engaging member 20, as best shown in FIG. 3, such that one of wires 14 generally pass between engaging member 20 and inner surface 16 of conduit 12.

In the preferred embodiment, first rigid member 42 has an outwardly facing proximal side 62 that cooperatively receives elongated connector 60 and a inwardly facing distal side 64 that is cooperatively configured to be received in bore 40 at the proximal end 24 of engaging member 20. As best shown in FIGS. 3 through 5, the proximal side 62 of first rigid member 42 is provided with a recessed area 66 that is shaped and configured to cooperatively receive the head member 68 at the proximal end 70 of elongated connector 60. Preferably, first aperture 48 is centered in recessed area 66 such that when elongated connector 60 is received through first aperture 48, bore 40 and second aperture 54, the edges of head member 68 thereof tightly engage the sides of recessed area 66 to further deter a thief or other unauthorized person from attempting to disengage tamper resistant plug 10 by making it nearly impossible to place a prying device under head member 68 to break it off of elongated connector 60. Likewise, it is preferred that the thickness of annular edge 52 of first rigid member 42 be selected so that when first rigid member 42 is received in recessed section 36 of proximal end 24 it does not extend past the proximal edge of sidewall 38 thereof (i.e., first rigid member 42 is even or below the outer/proximal edge of the sidewall 38) so as to substantially prevent someone from prying first rigid member 42 off of tamper resistant plug 10. In the preferred embodiment, the distal side 72 of first rigid member 42 has an protruding portion 74, shown in FIG. 5, that extends generally distally from first rigid member 42 into bore 70 to help maintain proper alignment between first rigid member 42 and engaging member 20. The cooperation between first annular grooves 50 and the portion of wire receiving grooves 30 in recessed section 36 at proximal end 24, as best shown in FIG. 3, also facilitates proper alignment between these components.

In one embodiment, distal end 26 of engaging member 20 and second rigid member 44 are configured to be substantially planar, with the proximal side 76 of second rigid member 44 in generally abutting relation with the distally facing surface of distal end 26 of engaging member 20. Because distal end 26 is disposed inwardly inside conduit 12, there is less of a concern with regard to a person prying apart the components at distal end 26 to disable the security provided by tamper resistant plug 10 of the present invention. In the preferred embodiment, however, distal end 26 has a recessed section 36 with upstanding sidewalls 38 (as shown in FIG. 5 for proximal end 24) and the thickness of second rigid member 44 is such that the annular edge 58 thereof does not extend above the distal edge of sidewalls 38. As with first rigid member 42, the cooperation between second annular grooves 56 and the portion of wire receiving grooves 30 in the recessed section 36 at distal end 26 facilitates proper alignment between these components. In a preferred configuration of biasing means 46, second aperture 54 of second rigid member 44 has an internally threaded section 78 that threadably connects to an external threaded section 80 at or towards the distal end 82 of elongated connector 60, as best shown in FIG. 5. In this embodiment, threading of elongated connector 60 into threaded section 78 of second aperture 54 draws first 42 and second 44 rigid members together to compress engaging member 20 therebetween. The preferred embodiment of second rigid member 44 includes a proximally disposed protruding portion 84 on its proximal side 76, as shown in FIGS. 5 and 8, that is received in bore 40 at the distal end 26 of engaging member 20. As with the protruding portion 74 of first rigid member 24, the protruding portion 84 of second rigid member 26 facilitates alignment of second rigid member 26 with engaging member 20. Second aperture 54, with threaded section 78 therein, passes through protruding portion 84 of second rigid member 26. If desired, the distal side 86 of second rigid member can be substantially planar or it can have a recessed area (not shown) similar to recessed area 66 of first rigid member 24.

As set forth above, biasing means 46 is configured to bias first rigid member 24 and second rigid member 26 together to compress engaging member 20 and extend the outer surface 28 thereof into engagement with the inner surface 16 of conduit 12 in order to prevent unauthorized removal of wires 14 from conduit 12. As also set forth above, in the preferred embodiment biasing means 46 is elongated connector 20 shown in the figures, which interconnects first 24 and second 26 rigid members by threadably engaging threaded section 80 on connector 60 with the threaded section 78 in second aperture 54 of second rigid member 24. In an alternative embodiment, shown in FIG. 8, a connector element 88, such as the nut shown, threadably attaches to threaded section 80 on connector 60 such that connector element 88 draws up against the distal side 86 of second rigid member 24, thereby interconnecting first 42 and second 44 rigid members. As known to those skilled in the art, other types of connectors and connector elements can be utilized with tamper resistant plug 10 of the present invention to bias first 42 and second 44 rigid members together so as to compress engaging member 20 as described herein.

Head member 68 of the elongated connector 60 of the preferred embodiment of the present invention is configured for the user to threadably connect threaded section 80 on connector 60 with the threaded section 78 in second aperture 54 or in the connector element 88 so as to bias first 42 and second 44 rigid members together. In one embodiment, head member 68 can be configured to be operated by a standard straight or phillips screwdriver or a standard socket. In the preferred embodiment, however, head member 68 is configured to require the use of a specially configured driver that is not readily available to the public or the use of a custom, proprietary driver that is not available to the public at all to improve the tamper resistance of tamper resistant plug 10. For instance, as best shown in FIGS. 3 through 5 and 9, head member 68 can be provided with one or more specially configured security features, shown as 90, that are commonly known in the art with regard to screws and bolts. Tamper resistant screws and bolts utilize specially configured heads that can only be operated by a cooperatively configured bit that is supplied to the user when ordering the screws or bolts. Many of the designs for security features 90 are proprietary, so that only the user is supplied with the bits that enable the connector 60 to be operated so as to loosen the compression on engaging member 20 and disengage tamper resistant plug 10 so that it and/or the wires 14 can be removed therefrom. Use of such proprietary features can essentially make connector 60 tamper proof. With a tamper resistant or proof security feature incorporated into connector 60, the user can be relatively confident that the typical thief or other unauthorized person will not be able to disengage tamper resistant plug 10 and remove wires 14 from conduit 12.

The preferred embodiment of tamper resistant plug 10 of the present invention includes a retaining means, such as retainer ring 92, best shown in FIGS. 4, 5 and 8. Retainer ring 92 is configured to be securely received on the distal end 82 of connector 60, as best shown in FIG. 4, to retain the components of tamper resistant plug 10 on connector 60 when it is disengaged. Without retainer ring 92, operation of connector 60 to disengage engaging member 20 from the inner surface 16 of conduit 12 could result in one or more of the components, particularly second rigid member 44 and connector element 88, moving distally into conduit 12, particularly if proximal end 18 of conduit 12 is generally vertically positioned. As best shown in FIGS. 5 and 8, distal end 82 of connector 60 can be configured with an annular groove 94 or the like that is specially configured to be engaged by retainer ring 92. Alternatively, the retaining means 92 can comprise a hole through connector 60 at its distal end 82 and the retainer element can be a cotter pin or the like device. As known to those skilled in the art, various other configurations of retaining means 92 can be utilized with tamper resistant plug 10 of the present invention to retain the components on the connector 60 when engaging member 20 is disengaged.

Typically, though not exclusively, tamper resistant plug 10 will be configured for a particular size of conduit 12 and range of wire sizes (such as one inch diameter conduit and #6 through #8 wire) and for a particular number of wires 14, typically three or four. The user will select the proper tamper resistant plug 10 based on the application he or she needs and be provided with a specially configured, preferably proprietary, bit that cooperatively engages security features 90 on the head member 68 of connector 60. The user will then separate the wires 14 in conduit 12 and place one of each of the wires 14 in wire receiving grooves 30 of engaging member 20. If the snap-in outer reaches 34 feature is utilized, then the user “pushes” the wire 14 into wire receiving grooves 30. The snap-in outer reaches 34 will free the user's hands to further install tamper resistant plug 10 into conduit 12. Otherwise, if tamper resistant plug 10 has open, arc-shaped grooves 30, as shown in FIG. 8, then he or she will need to maintain wires 14 against the engaging surfaces during installation. With elongated connector 60 loosely connected at its distal end 82 to second rigid member 44 or connector element 88, the user places tamper resistant plug 10 inside the proximal end 18 of conduit 12, generally only a relatively slight distance back from the proximal end 18. The user then utilizes the special bit to operate/tighten connector 60, which will bias first 42 and second 44 rigid members together to compress engaging member 20. This will cause the outer surface 28 of engaging member 20 to extend radially towards inner surface 16. Continued operation/tightening of connector 60 will dispose outer surface 28 against inner surface 16 of conduit 12 to engage outer surface 28 therewith. This will compress wires 14 generally between engaging member 20 (inside wire receiving grooves 30) and inner surface 16 of conduit 12. Once set, the user removes the bit from head member 68 and connects the portion of wires 14 extending outwardly of the proximal end 18 of conduit 12 to other wires or to an electrical device. With the wires 14 tightly compressed between engaging member 20 and inner surface 16, the resistance to pulling on wires 14 will be such that any thief or other unauthorized person that attempts to pull wires 14 out of conduit 12 will be unable to do so, thereby saving the owner the cost of the material and labor to replace wires 14.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A tamper resistant plug for securing one or more wires in a conduit, said tamper resistant plug comprising:
a deformable engaging member formed from a resilient material having a proximal end, a distal end and an outer surface therebetween, said outer surface in conforming relation with an inner surface of said conduit, said outer surface having one or more wire receiving grooves therein, each of said wire receiving grooves having an outwardly facing engaging surface dimensioned to receive one of said one or more wires; and
means associated with said engaging member for compressing said engaging member to extend said outer surface in a generally radial direction so as to dispose said outer surface against said inner surface of said conduit to secure one of said one or more wires in one of said one or more wire receiving grooves to prevent removal of said one or more wires from said conduit.

2. The tamper resistant plug according to claim 1, wherein said wire receiving grooves are configured to compress said engaging surface generally against said inner surface of said conduit to secure said wires between said engaging member and said conduit.

3. The tamper resistant plug according to claim 1, wherein said compressing means comprises a first rigid member at said proximal end of said engaging member, a second rigid member at said distal end of said engaging member and means for biasing said first rigid member and said second rigid member toward each other to radially extend said outer surface of said engaging member.

4. The tamper resistant plug according to claim 3, wherein said biasing means comprises an elongated connector having a proximal end at said first rigid member and a distal end at said second rigid member.

5. The tamper resistant plug according to claim 4 further comprising a bore through said engaging member, a first aperture in said first rigid member and a second aperture in said second rigid member, said bore, said first aperture and said second aperture substantially aligned, said elongated connector extending from said first rigid member through said bore to operatively engage said second rigid member.

6. The tamper resistant plug according to claim 5, wherein said proximal end of said elongated connector comprises a head member configured to be substantially tamper resistant.

7. The tamper resistant plug according to claim 6, wherein said first rigid member has a recessed area on a proximal side thereof shaped and configured to receive said head member, said first aperture disposed in said recessed area, said recessed area and said head member cooperatively configured to further deter unauthorized removal of said connector from said engaging member.

8. The tamper resistant plug according to claim 6, wherein said elongated connector has an external threaded section and said second aperture has an internal threaded section, said external threaded section of said elongated connector threadably engaging said internal threaded section of said second aperture.

9. The tamper resistant plug according to claim 6 further comprising a connector element at said distal end of said elongated connector configured to engage a distal side of said second rigid member to bias said first rigid member and said second rigid member toward each other.

10. The tamper resistant plug according to claim 4 further comprising means at said distal end of said elongated connector for retaining said second rigid member on said elongated connector.

11. The tamper resistant plug according to claim 3, wherein each of said first rigid member and said second rigid member has one or more annular grooves on an outer annular edge thereof, said annular grooves in corresponding relation to said wire receiving grooves on said engaging member, said annular grooves shaped and configured to allow one of said one or more wires to pass between said tamper resistant plug and said inner surface of said conduit.

12. A tamper resistant plug for securing one or more wires in a conduit, said tamper resistant plug comprising:
a deformable engaging member formed from a resilient material having a proximal end, a distal end, an outer surface therebetween and a bore disposed therethrough, said outer surface in conforming relation with an inner surface of said conduit, said outer surface having one or more wire receiving grooves therein, each of said wire receiving grooves having an outwardly facing engaging surface dimensioned to receive one of said one or more wires;
a first rigid member disposed at said proximal end of said engaging member, said first rigid member having a first aperture in substantial alignment with said bore;
a second rigid member disposed at said distal end of said engaging member, said second rigid member having a second aperture in substantial alignment with said bore; and
means for biasing said first rigid member and said second rigid member towards each other to compress said engaging member and extend said outer surface thereof in a generally radial direction to engage said inner surface of said conduit so as to secure one of said one or more wires generally between said engaging member and said inner surface of said conduit to prevent removal of said one or more wires from said conduit.

13. The tamper resistant plug according to claim 12, wherein said biasing means comprises an elongated connector having a proximal end and a distal end, said elongated connector extending from said first rigid member through said bore to engage said second rigid connector.

14. The tamper resistant plug according to claim 13, wherein said proximal end of said elongated connector comprises a head member configured to be substantially tamper resistant.

15. The tamper resistant plug according to claim 14, wherein said first rigid member has a recessed area on a proximal side thereof shaped and configured to receive said head member, said first aperture disposed in said recessed area, said recessed area and said head member cooperatively configured to further deter unauthorized removal of said connector from said engaging member.

16. The tamper resistant plug according to claim 13 further comprising means at said distal end of said elongated connector for retaining said second rigid member on said elongated connector.

17. The tamper resistant plug according to claim 12, wherein each of said first rigid member and said second rigid member has one or more annular grooves on an outer annular edge thereof, said annular grooves in corresponding relation to said wire receiving grooves on said engaging member, said annular grooves shaped and configured to allow one of said one or more wires to pass between said tamper resistant plug and said inner surface of said conduit.

18. A tamper resistant plug for securing one or more wires in a conduit, said tamper resistant plug comprising:
a deformable engaging member formed from a resilient material having a proximal end, a distal end, an outer surface therebetween and a bore disposed therethrough, said outer surface in conforming relation with an inner surface of said conduit, said outer surface having one or more wire receiving grooves therein, each of said wire receiving grooves having an outwardly facing engaging surface dimensioned to receive one of said one or more wires;
a first rigid member disposed at said proximal end of said engaging member, said first rigid member having a first aperture in substantial alignment with said bore and one or more first annular grooves on an annular edge thereof in substantial corresponding arrangement with said one or more wire receiving grooves;
a second rigid member disposed at said distal end of said engaging member, said second rigid member having a second aperture in substantial alignment with said bore and one or more second annular grooves on an annular edge thereof in substantial corresponding arrangement with said one or more wire receiving grooves; and
a connector having a proximal end at said first rigid member and a distal end at said second rigid member, said connector further comprising a head member at said proximal end configured to be substantially tamper resistant, said connector configured to bias said first rigid connector and said second rigid connector towards each other to compress said engaging member and extend said outer surface thereof in a generally radial direction to engage said inner surface of said conduit and secure one of said one or more wires generally between said engaging member and said inner surface of said conduit to prevent removal of said one or more wires from said conduit.

19. The tamper resistant plug according to claim 18, wherein said first rigid member has a recessed area on a proximal side thereof shaped and configured to receive said head member, said first aperture disposed in said recessed area, said recessed area and said head member cooperatively configured to further deter unauthorized removal of said connector from said engaging member.

20. The tamper resistant plug according to claim 18 further comprising means at said distal end of said elongated connector for retaining said second rigid member on said elongated connector.

21. The tamper resistant plug according to claim 18, wherein said engaging member has a recessed section defined by one or more upstanding sidewalls at said proximal end thereof, said recessed section shaped and configured to receive said first rigid member therein.
